(19) United States
(12) Patent Application Publication
(10) Pub. No.: US 2013/0125921 A1
(43) Pub. Date: May 23, 2013

(54) Method and Apparatus for a Makeup Applicator

(71) Applicant: Wayne Celia, Woonsocket, RI (US)

(72) Inventor: Wayne Celia, Woonsocket, RI (US)

(21) Appl. No.: 13/298,426

(22) Filed: Nov. 17, 2011

(51) Int. Cl. A46B 7/04; B23P 11/00; A45D 33/00

(52) U.S. Cl. 132/313; 132/317; 29/428

(57) ABSTRACT

The invention relates to a makeup applicator comprising a ferrule and a series of reversibly attachable, interchangeable heads and a method of making the same. Through these interchangeable heads, the instant invention allows for quick and convenient use of multiple makeup applicators that are relatively simple to manufacture, stable enough to be used with precision, and highly adaptable.

### FIELD OF INVENTION

The invention relates to a makeup applicator, and more particularly, to an improved makeup applicator with a multiplicity of interchangeable heads. Each head includes a spring which reversibly engages a ferrule, enabling the substitution of applicator heads on a single handle-ferrule assembly.

### BACKGROUND OF INVENTION

A wide variety of cosmetic compositions have been developed, and many compositions can be applied using an ever-increasing variety of techniques. Compositions include powders differing greatly in particle size and stickiness, gels of differing thicknesses and homogeneities, pastes of differing translucencies and textures, and even solids and semi-solids of varying frangibilities. This variety of compositions has led to a corresponding variety of applicators, and creativity in techniques for applying, blending, daubing, and otherwise manipulating makeup compositions has vastly increased this diversity in types of useful applicators. The expense of maintaining even a modest range of applicators has grown, as has the amount of space required to store such a collection. Wear on these applicators also typically occurs only on the tips, and the applicators must be replaced due to tip wear long before there is any evident wear on other parts of the applicators.

It is desirable, therefore, to provide an applicator having interchangeable heads which can be quickly and easily changed. This type of applicator and its associated heads would reduce the initial expense and the storage requirements of a set of conventional applicators, since one handle would be sufficient for a wide variety of applicator heads. It would also reduce the replacement costs of worn applicators, as only the applicator head would need to be replaced. To be of maximum use, it is desirable that the interchangeability of the heads be quick and simple so that it would be as convenient to change heads as to pick up a separate applicator. It is also desirable that the mechanism involved in interchanging the heads be simple enough not to add unduly to the costs of manufacture compared to a conventional applicator.

Other examples of makeup applicators haying interchangeable heads have been proposed. Dorf, in U.S. 2004/0168700, appears to show a portable cosmetic brush set with a single handle and a multiplicity of brushes affixed to ferrules which can be individually affixed to the handle. These brushes appear to be held to the handle only by the friction between the handle and the ferrule, and wear or small inconsistencies in manufacture lead to movement of the ferrule on the brush during use and consequent loss of precision in application of the cosmetics. This set also makes no provision for applicators other than brushes.

Hirzel, in U.S. Pat. No. 5,176,754 appears to propose a double-ended makeup applicator, in some embodiments of which, one end or the other is removably attached. The mechanism for removing the applicator appears to be a push-button locking pin attached to the removable head.

Piao, in U.S. 2008/0283083 appears to propose a head-switchable brush in which each head is affixed to a ferrule containing a magnet. A handle containing a second magnet can be switched from head to head, the various heads being held to the handle by the attraction between the two magnets.

There still exists, a need for a makeup applicator with interchangeable heads which is relatively simple to manufacture, stable enough to be used with precision, adaptable to a wide variety of different applicator heads, and quick and convenient to change from one head to another.

### SUMMARY OF INVENTION

It is therefore an object of this invention to provide a makeup applicator comprising a ferrule, at least a first and second applicator head removably attached to the ferrule and each head being interchangeable with one another, and a spring attached to the applicator heads for engaging with the ferrule to removably attach each of the applicator heads to the ferrule. In some embodiments, each of the applicator heads comprises a clip spring biased in an outward direction for attachment of the clip to an inner diameter of the ferrule.

In one embodiment, the ferrule is an elongated tube. In another embodiment, the ferrule includes a groove on its inner surface for engaging a protrusion on the outer surface of a clip spring.

In some embodiments, the invention further comprises a handle attached to the ferrule opposite the applicator head. In one embodiment, the invention comprises a plurality of applicator heads, each head being different than a next head. In some embodiments, each applicator head has a brush different than a brush of the next head.

It is a further object of this invention to provide a makeup applicator comprising a handle; a ferrule attached to the handle; a first and second applicator head, each removably attached to the ferrule and interchangeable with one another; a spring attached to each of the applicator heads for engaging with the ferrule to removably attach the applicator heads to the ferrule; and each applicator head including a clip spring biased in an outward direction for attachment of the applicator heads to an inner diameter of the ferrule. In some embodiments, the invention further comprises a plurality of applicator heads, each head being different than a next head. In some embodiments, each applicator head has a brush different than a brush of the next head.

In some embodiments, the handle further comprises an attachment mechanism whereby the ferrule is removably attached to the handle. In one embodiment, the spring on each applicator head further comprises a protrusion on its outer surface; and said ferrule further comprises a groove on its inner surface for reversibly engaging said protrusion.

It is a still further object of this invention to provide a method of making a makeup applicator, comprising the steps of providing a ferrule, providing a first applicator head and a second applicator head, attaching a spring to each of the applicator heads, and removably attaching the first and second applicator heads, to the ferrule by engaging an inner diameter of the ferrule with the spring of the removably attached head. In one embodiment, the method comprises the additional steps of providing a protrusion on the outer surface of the spring and providing a groove on the inner diameter of the ferrule, such that the protrusion engages the groove when engaging the inner diameter of the ferrule with the spring.

It is a further object of this invention to provide an applicator head for a makeup applicator comprising a spring attached to a tip end. In some embodiments, the applicator head further comprises a brush attached to the tip end. In some embodiments, the spring includes a clip spring being biased in an outward direction for engaging an inner diameter of a ferrule.

It is yet a further object of this invention to provide a plurality of applicator heads, each head having a brush different than a brush of the next head and each head being interchangeable with one another, and a spring attached to each of the applicator heads for engaging with a ferrule, wherein each of the heads is adapted to be removably attached to the ferrule.

In some embodiments, the ferrule is an elongated tube. In some embodiments, each applicator head includes a clip spring biased in an outward direction for attachment of each clip to an inner diameter of the ferrule. In one embodiment, the clip spring includes a protrusion on its outer surface, for engaging an indentation on the inner surface of the ferrule.

Some embodiments further comprise a plurality of applicator heads, each head being different than a next head. In some embodiments, each applicator head has a brush different than a brush of the next head.

### BRIEF DESCRIPTION OF FIGURES

The features of the invention believed to be novel and the elements characteristic of the invention are set forth with particularity in the claims. The figures are for illustration purposes only. The invention itself, however, both as to organization and method of operation, may be understood by reference to the detailed description which follows taken in conjunction with the accompanying drawings in which the drawings show typical embodiments of the invention and are not intended to be limited of its scope.

FIG. 1 depicts one embodiment of a makeup applicator in accordance with the present invention, assembled.

FIG. 2 depicts one embodiment of a makeup applicator in accordance with the present invention as shown in FIG. 1, disassembled into its component parts.

FIG. 3 depicts a cutaway view of one embodiment of a makeup applicator in accordance with the present invention as shown in FIG. 1.

FIG. 4 depicts a cutaway view of a second embodiment of a makeup applicator in accordance with the present invention as shown in FIG. 1.

FIG. 5 depicts front and side views of an applicator head in accordance with an embodiment of the present invention, with and without a removable tip in place.

FIG. 6 depicts applicator heads in accordance with an embodiment of the present invention as shown in FIG. 5 with a variety of removable tips.

FIG. 7 depicts applicator heads in accordance with an embodiment of the present invention as shown in FIG. 5 with a variety of brushes.

FIG. 8 depicts a method of making a makeup applicator in accordance with one embodiment of the invention as shown in FIG. 1.

FIG. 9 depicts an embodiment of the method of making a makeup applicator as show in FIG. 8.

FIG. 10 depicts an embodiment of the method of making a makeup applicator as show in FIG. 8.

### DETAILED DESCRIPTION

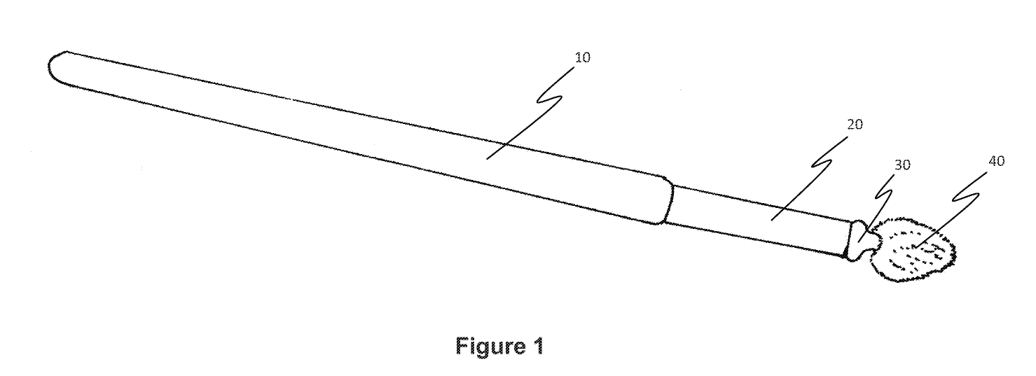

In describing the various embodiments of the instant invention, reference will be made herein to FIGS. 1-10 in which like numerals refer to like features of the invention.

FIG. 1 depicts one embodiment of a makeup applicator in accordance with the present invention, assembled for use. In this embodiment, the ferrule (20) is attached to a handle (10), and removably attached to an applicator head (30), which supports an applicator pad (40).

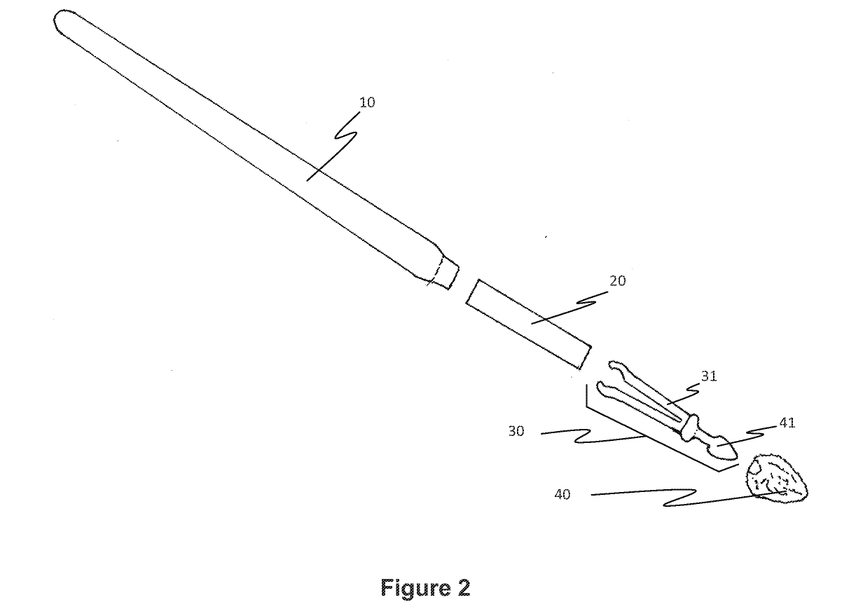

FIG. 2 depicts one embodiment of a makeup applicator in accordance with the present invention, disassembled into its component parts. In one embodiment, an interchangeable applicator head (30), which comprises a spring end (31) and a stud end (41). The spring end in this embodiment is a clip spring removably attached to the ferrule (20) by insertion of the spring into the ferrule such that the spring end engages an inner diameter of the ferrule. The ferrule is attached to the handle (10) by sliding it onto a section of the handle tapered to fit into the inner diameter of the ferrule. The stud end of the applicator head is inserted into an opening on an applicator pad.

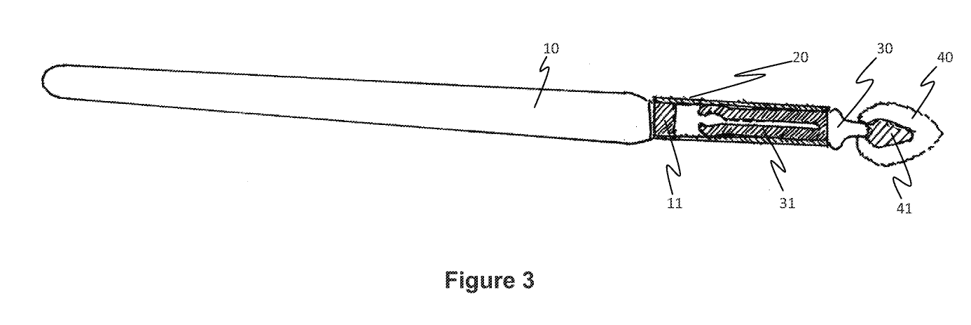

FIG. 3 depicts one embodiment of a makeup applicator in accordance with the present invention in a cutaway view showing the component parts in their assembled internal relationships. The handle (10) is attached to the ferrule (20) by an attachment mechanism comprising a tapered end of the handle (11) inserted into the base of the ferrule. The applicator head (30) is removably attached to the ferrule by insertion of the attached clip spring (31) into the ferrule such that the spring engages the interior diameter of the ferrule. The stud end of the applicator head (41) is inserted into the applicator pad (40).

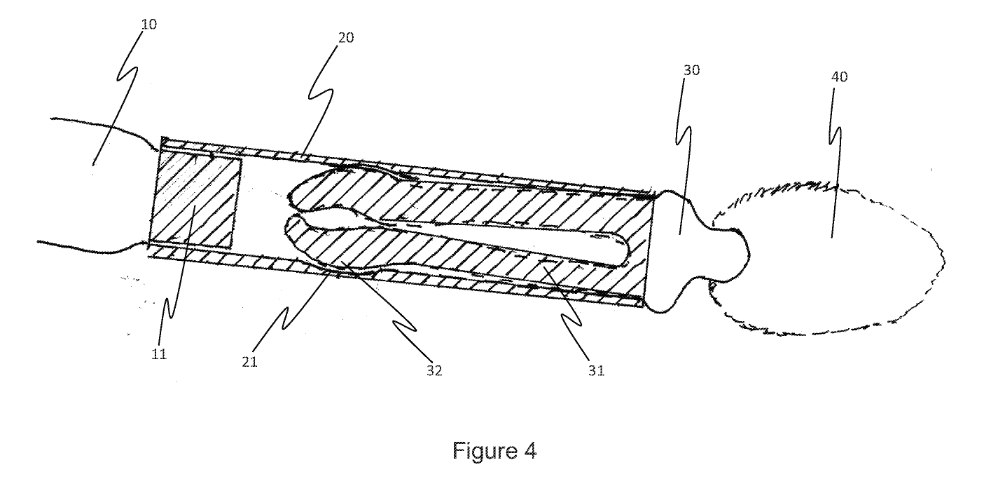

FIG. 4 depicts one embodiment of a makeup applicator in accordance with the present invention, in a cutaway view showing the component parts in their assembled internal relationships. In this embodiment, the ferrule (20) is shaped with a groove (21) in its inner diameter, and the spring end of the applicator head (31) is fitted with a protrusion (32) shaped to engage the groove (21) in the inner diameter of the ferrule.

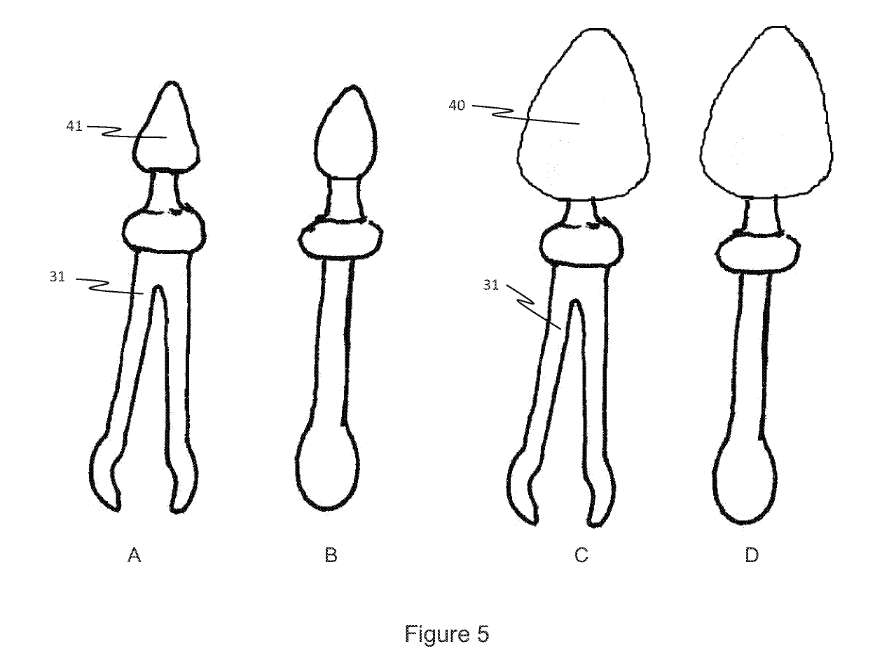

FIG. 5 shows an applicator head for one embodiment of the present invention, with a front view (A) and side view (B) of an applicator head with the applicator pad removed showing the stud end (41) and spring end (31), and a front view (C) and side view (D) of the same applicator head with an applicator pad (40) in place.

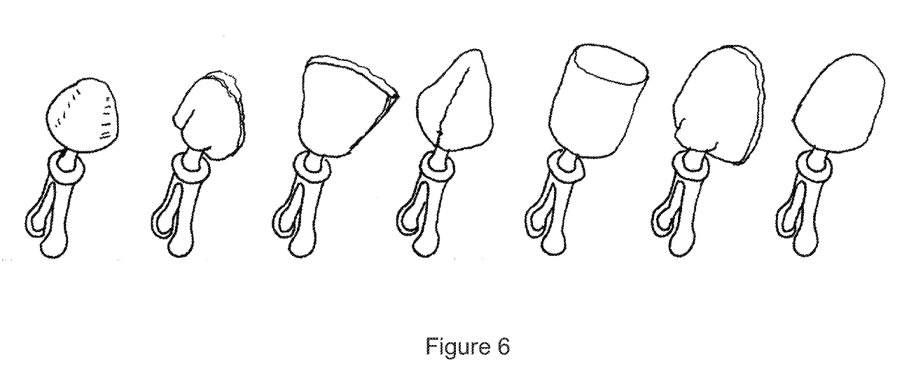

FIG. 6 shows an assortment of applicator pads suitable for certain embodiments of the present invention, shown in place on applicator heads.

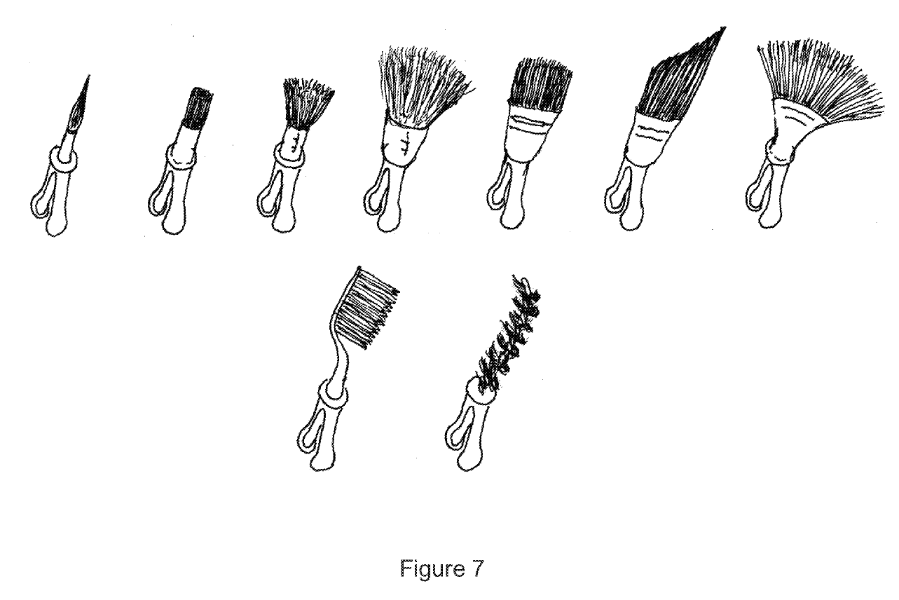

FIG. 7 shows an assortment of applicator heads with varying brush heads suitable for certain embodiments of the present invention.

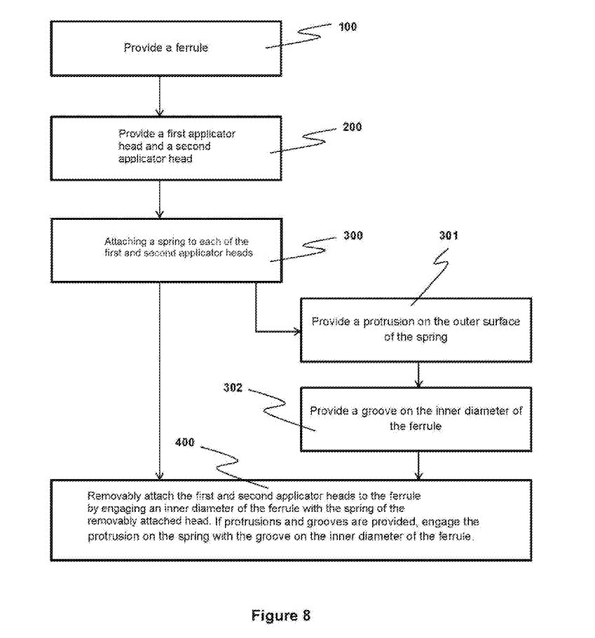

FIG. 8 shows a flowchart for a method for providing a makeup applicator of the present invention, comprising the steps of providing a ferrule (100), providing applicator heads (200), attaching springs to the applicator heads (300), and attaching an applicator head to the ferrule by engaging an inner diameter of the ferrule with the spring of the applicator head (400). In some embodiment, the method comprises the additional steps of providing a protrusion on the outer surface of the spring (301) and providing a groove on the inner diameter of the ferrule (302), and engaging the protrusion on the spring with the groove on the inner diameter of the ferrule when the applicator head is attached to the ferrule (400).

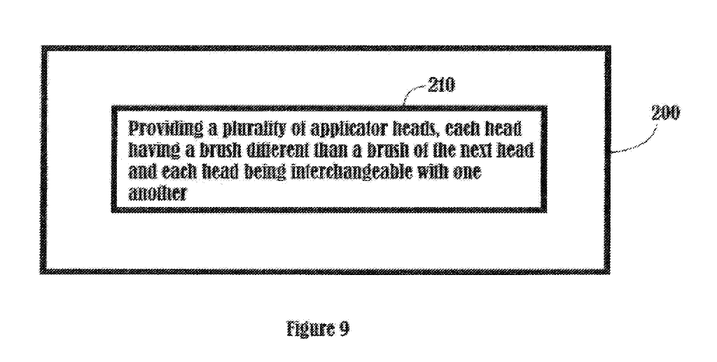

FIG. 9 shows an embodiment of the method of making a makeup applicator of the present invention as shown in FIG. 8, further comprising the step of providing a plurality of applicator heads (210), each head having a brush different than a brush of the next head and each head being interchangeable with one another.

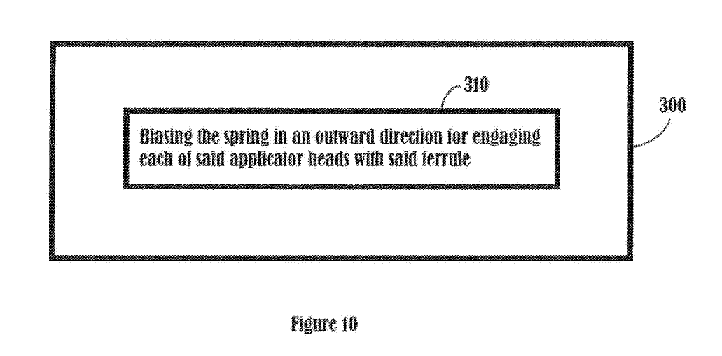

FIG. 10 shows an embodiment of the method of making a makeup application of the present invention as shown in FIG. 9, further comprising the step a biasing the spring in an outward direction (310) for engaging each of said applicator heads with said ferrule.

In some embodiments, the handle is permanently attached to the ferrule. In one embodiment, the ferrule is glued to the handle. In another embodiment, a solvent is applied to the interface between the handle and the ferrule, such that the solvation of small amounts of material comprising the ferrule and the handle followed by evaporation of the solvent forms a bond between the handle and the ferrule. In other embodiments, an energy such as electrical, microwave radiation, infrared radiation, or heat is applied to partially melt the handle or ferrule at the interface, such that the melting and subsequent cooling of the interface will form an attachment.

In other embodiments, an attachment mechanism allows the handle and ferrule to be removably attached. In one embodiment, mating threads are formed on the outer diameter of one end of the handle and on the inner diameter of the ferrule, and the handle and ferrule are screwed together. In some embodiments, the end of the handle is tapered to have a portion with an outer diameter substantially the same as the inner diameter of the ferrule, so that friction between the tapered portion of the handle and the inner diameter of the ferrule are sufficient to keep the ferrule in place during normal use. In one embodiment, a bayonet-type fitting is used, wherein the outside diameter of one end of the handle is fitted with one or more studs, and the ferrule is fitted with corresponding L-shaped slots such that the studs on the handle are inserted into the slots and twisted to lock the ferrule in place. In another embodiment, one or more studs protruding inward from the ferrule fit into corresponding. L-shaped grooves in one end of the handle, locking the ferrule to the handle. In still other embodiments, locking fittings are attached to the handle and the ferrule, removably attaching the handle to the ferrule. Other mechanisms for attaching the handle to the ferrule can be contemplated without departing from the current invention.

In some embodiments, the ferrule is a cylindrical tube with an inner diameter sized such that a portion of the handle is inserted in one end and the spring of an applicator head into the other end. In other embodiments, the ferrule is a tapered cylindrical tube with a larger end sized to fit on a tapered portion of the handle, and a smaller end sized to fit the spring of an applicator head, so that the expansion of the spring against the inner diameter of the ferrule will tend to draw the applicator head towards the handle. In some embodiments, the inner wall of the ferrule is grooved to correspond with a protrusion on the outer face of the spring, such that expansion of the spring will press the protrusion into the groove, holding the head firmly in place. In other embodiments, dimples in the inner diameter of the ferrule are sized and placed to accept protrusions on the outer faces of the spring. The choice of shape and regularity of the inner diameter of the ferrule and the outer face of the slip spring, and the choice of number and geometry of mating protrusions and grooves are made based on the amount of force desired to remove the head from the ferrule. A cylindrical, smooth inner diameter on the ferrule with a small amount of contact surface to the spring will be easier to separate than a tapered ferrule and a higher contact surface, and addition of mating protrusions and grooves will increase the force required.

In some embodiments of this invention, interchangeable applicator heads are provided. In some embodiments, these applicator heads comprise a spring end and an applicator end. In one embodiment, the spring end comprises an outwardly biased clip spring, sized such that when compressed, it will fit inside the inner diameter of a ferrule, Subsequent expansion of the clip spring against the inner diameter of the ferrule holds the applicator in place during use white force applied to the applicator head in a direction away from the ferrule allows the spring to be removed from the ferrule so the head can be changed.

In some embodiments of the invention, the applicator end of the applicator head comprises a brush. In one embodiment of the invention, a plurality of interchangeable applicator heads is provided wherein each applicator head has a brush different from the brush on a next applicator head. In some embodiments of the invention, the applicator end of the applicator head comprises an applicator pad, and in some embodiments, a plurality of interchangeable applicator heads is provided wherein each applicator head has an applicator pad different from the pad on a next applicator head. In one embodiment of the invention, the applicator head comprises a stud and an applicator pad attached to the stud. In one embodiment, the applicator pads are removed and replaced due to wear. In another embodiment, the applicator path are removed and replaced to allow the use of other pads of different shapes and materials.

In other embodiments, the applicator head comprises a cosmetic substance compressed into a form which allows the substance to be rubbed onto the skin from the surface of the form. In one embodiment, the form is supported by a cylinder of wood in the form of a pencil. In other embodiments, the form is freestanding. The shape of the form is selected to match the desired method of application.

While the present invention has been particularly described, it is evident that many alternatives, modifications and variation's will be apparent to those skilled in the art in light of the foregoing description. It is therefore contemplated that the appended claims will embrace any such alternatives, modifications, and variations as falling within the true scope and spirit of the present invention.

What is claimed is:

1. A makeup applicator, comprising:
a ferrule;
a first applicator head and a second applicator head, each removably attached to said ferrule and each head being interchangeable with one another; and
a spring attached to each of said first and second applicator heads for engaging with said ferrule to removably attach each of said first and second heads to said ferrule.

2. The makeup applicator according to claim 1, wherein each of said first and second heads includes a clip spring biased in an outward direction for attachment of said each clip to an inner diameter of said ferrule.

3. The makeup applicator according to claim 1, wherein said ferrule is an elongated tube.

4. The makeup applicator according to claim 1, further comprising a handle attached to said ferrule opposite said first and second applicator heads.

5. The makeup applicator according to claim 1, further comprising a plurality of applicator heads, each head being different than a next head.

6. The makeup applicator according to claim 1, further comprising a plurality of applicator heads, each head having a brush different than a brush of the next head.

7. The makeup applicator according to claim 2, wherein:
said clip spring includes a protrusion on its outer surface; and
wherein said ferrule includes a groove on its inner surface for reversibly engaging said protrusion.

8. The makeup applicator according to claim 1, further comprising a handle having an attachment mechanism whereby said handle is removably attached to said ferrule.

9. The makeup applicator according to claim 8 wherein said attachment mechanism is a tapered end inserted into said ferrule for removably attaching said handle to said ferrule.

10. A method of providing a makeup applicator, comprising the steps of:
providing a ferrule;
providing a first applicator head and a second applicator head;
attaching a spring to each of the first and second applicator heads; and
removably attaching the first and second applicator heads to the ferrule by engaging an inner diameter of the ferrule with the spring of the removably attached head.

11. The method of claim 10, further comprising the additional steps of:
providing a protrusion on the outer surface of said spring;
providing a groove on the inner diameter of said ferrule;
engaging, said protrusion with said groove when engaging the inner diameter of the ferrule with the spring of the removably attached head.

12. The method of claim 10, further comprising the step of providing a plurality of applicator heads, each head having a brush different than a brush of the next head and each head being interchangeable with one another.

13. The method of claim 10, further comprising the step of biasing the spring in an outward direction for engaging each of said applicator heads with said ferrule.

14. An applicator head for a makeup applicator comprising a spring attached to a tip end.

15. The applicator head of claim 14, further comprising a brush attached to said tip end.

16. The applicator head of claim 14, wherein the spring is biased in an outward direction for engaging an inner diameter of a ferrule.

17. A plurality of applicator heads of claim 16, each head having a brush different than a brush of the next head and, each head being interchangeable with one another; and said spring of each of said plurality of applicator heads is adapted for engaging with a ferrule, whereby each of said plurality of heads is adapted to be removably attached to the ferrule.
